(19) United States
(12) Patent Application Publication
(10) Pub. No.: US 2018/0057695 A1
(43) Pub. Date: Mar. 1, 2018

(54) SURFACE TREATMENT AGENT FOR METAL MATERIAL, AND METAL MATERIAL HAVING SURFACE TREATMENT COAT

(71) Applicant: NIHON PARKERIZING CO., LTD., Tokyo (JP)

(72) Inventors: Junichi UCHIDA, Tokyo (JP); Ichiro OURA, Tokyo (JP); Keiichi NAKAJIMA, Tokyo (JP)

(21) Appl. No.: 15/562,704

(22) PCT Filed: Mar. 18, 2016
(86) PCT No.: PCT/JP2016/058803

§ 371 Date: Sep. 28, 2017

(30) Foreign Application Priority Data
Mar. 31, 2015 (JP) 2015-074296

(51) Int. Cl. C09D 5/08; C23F 11/173; B32B 15/08; C09D 183/04

(52) U.S. Cl. CPC C09D 5/084; C09D 183/04; B32B 15/08; C23F 11/173

(57) ABSTRACT

The present invention provides a surface treatment agent for metal materials, with which it is possible to form on a metal material a coat that is satisfactory overall in terms of properties such as corrosion resistance, adhesion, water resistance, alkali resistance, and solvent resistance, and that has excellent corrosion resistance and adhesion even when exposed to high-temperature environments; and a metal material having a surface treatment coat. This surface treatment agent for metal materials includes (A) an organopolysiloxane compound having a weight-average molecular weight of 400-10,000 and including a unit (X) the molecule of which has a phenyl group, and a unit Y which includes a group having a C1-3 alkyl group, the ratio (β/α) of the molar amount (α) of the units (X) and the molar amount (β) of all constituent units being 1.5 or greater, (B) coated aluminum particles surface-treated by an organosiloxane compound each single molecule of which has a hydrolysable group linked to a silicon atom; and (C) at least one component selected from the group consisting of metal oxide particles and clay minerals.

### TECHNICAL FIELD

The present invention relates to a surface treatment agent for metal materials that is favorably used in surface treatment of metal materials of electronic parts and micro device parts for use in automobiles, home electric appliances, office automation equipment and other devices, as well as a metal material having a surface treatment coating (with excellent corrosion damage resistance) obtained by surface treatment using this surface treatment agent for metal materials.

### BACKGROUND ART

Metal materials (particularly, metal materials for electronic parts and micro device parts) are used in products utilized in various fields, for instance, fields of automobiles, home electric appliances and office automation equipment, and used in various environments such as indoor and outdoor environments, a marine atmosphere and a factory atmosphere. Thus, metal materials are required to withstand harsh environments.

In particular, electronic parts and micro device parts have been downsized and miniaturized with recent progress in their functionality and higher density, and techniques for forming a coating on a metal material have been developed in order to protect metal materials of such electronic parts and micro device parts.

For example, there is an embodiment in which an organic coating is provided on a metal material surface, more specifically, a surface treatment coating primarily composed of an organic component or a protection coating using a sealant is provided. More specifically, Patent Literature 1 discloses a method of treating a surface of an electronic part or a micro device part by causing a water dispersible organic polymer resin to be self-deposited on the surface; and Patent Literature 2 discloses a method of treating a surface of a metal material with an organic coating using a sealant containing a specific acrylic resin and an inorganic filler.

In addition to methods involving provision of an organic coating as above, surface treatment methods for metal materials include a method of providing an inorganic coating as described in Patent Literature 3. More specifically, Patent Literature 3 discloses a method of providing a coating using a composition containing a phosphoric acid-based compound, a fluoro acid including predetermined elements such as titanium and zirconium, and a silane coupling agent.

### CITATION LIST

### Patent Literature

Patent Literature 1: JP 2003-145034 A
Patent Literature 2: JP 2005-298765 A
Patent Literature 3: JP 2006-213958 A

### SUMMARY OF INVENTION

### Technical Problems

As described above, metal materials are often used in harsher environments in recent years, and accordingly, coatings covering their surfaces are required to have much higher levels of properties (corrosion resistance, adhesion, water resistance, alkali resistance, solvent resistance).

Aside from that, metal materials for electronic parts and micro device parts may be exposed to high temperature during production before serving as a final product, or may be installed near an engine of a vehicle or incorporated in an electronic device and exposed to a high temperature environment during use. Thus, metal materials are sometimes exposed to high temperature environments, and even in such cases, their coatings are required to exhibit excellent corrosion resistance and adhesion.

In the embodiments using the organic coatings described in Patent Literatures 1 and 2, however, when an organic coating is exposed to a high temperature environment, an organic substance constituting the organic coating is decomposed, so that desired properties are not exhibited.

In the embodiment using the predetermined inorganic coating described in Patent Literature 3, most of coating ingredients are not decomposed but remain under a high temperature environment. Meanwhile, the environment to which electronic parts and micro device parts are exposed changes to a high temperature state when in use and to a room temperature state when not in use, and accordingly, metal materials are repeatedly subject to thermal expansion and contraction. Under such conditions, cracks are liable to occur in the inorganic coating of Patent Literature 3, and thus corrosion resistance and adhesion are not sufficient after exposure to a high temperature environment.

In addition, when properties of a coating such as corrosion resistance, adhesion, water resistance, alkali resistance and solvent resistance are not excellent comprehensively, local corrosion current is likely to occur, which may cause so-called corrosion damage.

In view of the situations described above, an object of the present invention is to provide a surface treatment agent for metal materials that can form, on/over a metal material, a coating being comprehensively satisfactory in such properties as corrosion resistance, adhesion, water resistance, alkali resistance and solvent resistance and exhibiting excellent corrosion resistance and adhesion even when exposed to high temperature.

Another object of the invention is to provide a metal material having a surface treatment coating that is formed using the surface treatment agent for metal materials.

### Solution to Problems

The present inventors have made an intensive study to achieve the objects and as a result found that the foregoing problems can be solved by using a surface treatment agent containing a predetermined organopolysiloxane compound, predetermined aluminum particles, and metal oxide particles and/or a clay mineral, and the invention has been thus completed.

Specifically, the foregoing objects can be achieved by the characteristic features below.

(1) A surface treatment agent for metal materials, comprising:

an organopolysiloxane compound (A) that is composed of one unit selected from the group consisting of an M unit (R₃SiO_{1/2}), a D unit (R₂SiO), a T unit (RSiO_{3/2}) and a Q unit (SiO₂), has a three-dimensional network structure including at least the T unit and/or the Q unit in a molecule, contains in a molecule a unit X including a group having a phenyl group and a unit Y including a group having an alkyl group with 1 to 3 carbon atoms, has a ratio (β/α) between a molar quantity of the unit X (α) and a molar quantity of all constitutional units (β) of 1.5 or higher, and has a weight-average molecular weight of 400 to 10,000 (where each R independently represents a monovalent organic group);

coated aluminum particles (B) that have an average particle size of 5 to 30 μm and an aspect ratio (length/thickness) of 10 to 400 and are obtained by treating surfaces of aluminum particles with an organosilane compound having a hydrolyzable group bonded to a silicon atom in a molecule; and

a component (C) including at least one selected from the group consisting of metal oxide particles and a clay mineral.

(2) The surface treatment agent for metal materials according to (1),

wherein the organopolysiloxane compound (A) is contained in an amount of 14 to 74 mass % with respect to total solids of the surface treatment agent for metal materials, and

wherein a mass ratio (B/A) between the organopolysiloxane compound (A) and the coated aluminum particles (B) is 0.04 to 0.7.

(3) The surface treatment agent for metal materials according to (1) or (2),

wherein a mass ratio (C/A) between the organopolysiloxane compound (A) and the component (C) is 0.25 to 4.0.

(4) The surface treatment agent for metal materials according to any one of (1) to (3),

wherein the component (C) includes metal oxide particles, and

wherein the metal oxide particles have an average particle size of 0.1 to 0.5 μm and contain titanium oxide (c1) having been subjected to surface treatment with an inorganic silicon compound.

(5) A metal material having a surface treatment coating, comprising: a metal material; and a coating formed by bringing the surface treatment agent for metal materials according to any one of (1) to (4) into contact with a surface of the metal material.

### Advantageous Effects of Invention

The invention can provide a surface treatment agent for metal materials that can form, on/over a metal material, a coating being comprehensively satisfactory in such properties as corrosion resistance, adhesion, water resistance, alkali resistance and solvent resistance and exhibiting excellent corrosion resistance and adhesion even when exposed to a high temperature environment.

The invention can also provide a metal material having a surface treatment coating that is formed using the surface treatment agent for metal materials.

### DESCRIPTION OF EMBODIMENTS

The surface treatment agent for metal materials and the metal material having a surface treatment coating according to the present invention are described below.

First, the surface treatment agent for metal materials (hereinafter sometimes simply called “surface treatment agent”) is described.

The surface treatment agent for metal materials according to the invention contains a predetermined organopolysiloxane compound (A), predetermined coated aluminum particles (B) and a component (C).

Ingredients contained in the surface treatment agent for metal materials according to the invention are described below.

### <Organopolysiloxane Compound (A)>

The surface treatment agent for metal materials according to the invention contains the organopolysiloxane compound (A).

The organopolysiloxane compound (A) is composed of one unit selected from the group consisting of an M unit (R₃SiO_{1/2}), a D unit (R₂SiO), a T unit (RSiO_{3/2}) and a Q unit (SiO₂), has a three-dimensional network structure including at least the T unit and/or the Q unit in the molecule, contains in the molecule a unit X including a group having a phenyl group and a unit Y including a group having an alkyl group with 1 to 3 carbon atoms, has a ratio (β/α) between the molar quantity of the unit X (α) and the molar quantity of all constitutional units (β) of 1.5 or higher, and has a weight-average molecular weight of 400 to 10,000.

The use of the organopolysiloxane compound (A) leads to a resultant coating with excellent corrosion resistance, adhesion, water resistance, alkali resistance and solvent resistance.

More specifically, the coating contains a siloxane bond (Si—O bond) derived from the organopolysiloxane compound (A), resulting in a poorly soluble coating. In particular, when the organopolysiloxane compound (A) contains a phenyl group in its constitutional unit, this leads to excellent adhesion between the organopolysiloxane compound (A) and a metal material. A constitutional unit having an alkyl group takes on a structure where the alkyl group faces outward in a dried coating. This leads to excellent barrier properties and consequently to improved corrosion resistance, water resistance, alkali resistance and solvent resistance. By using the organopolysiloxane compound (A) in combination with the coated aluminum particles (B) and the component (C) which will be described later, a resultant coating exhibits excellent corrosion resistance and adhesion even when exposed to a high temperature environment. When one of those substances are used alone, excellent properties are not obtained; the use of the organopolysiloxane compound (A), the coated aluminum particles (B) and the component (C) in combination generates synergy and leads to excellent properties.

The term “high temperature environment” used herein represents an atmosphere at 600° C. or higher in an air environment.

The organopolysiloxane compound (A) content of the surface treatment agent for metal materials is not particularly limited but is preferably 10 to 85 mass %, more preferably 14 to 74 mass % and still more preferably 25 to 58 mass % with respect to the total solids in the surface treatment agent. When the content falls within the foregoing ranges, a resultant coating is further excellent in at least one of various properties (corrosion resistance, adhesion, water resistance, alkali resistance and solvent resistance, as well as corrosion resistance and adhesion after exposure to a high temperature environment) (hereinafter sometimes simply referred to as “the invention can have more excellent effect(s)”).

The term “total solids” used herein represents ingredients (e.g., the organopolysiloxane compound (A), the coated aluminum particles (B) and the component (C)) composing a coating to be described later and does not include a volatile component such as a solvent.

The organopolysiloxane compound (A) is composed of one unit selected from the group consisting of the M unit (R₃SiO_{1/2}), the D unit (R₂SiO), the T unit (RSiO_{3/2}) and the Q unit (SiO₂), and has a three-dimensional structure (three-dimensional network structure) including at least the T unit and/or the Q unit in the molecule. Exemplary combinations include M/D/T type, M/D/T/Q type, M/D/Q type, M/T type, M/T/Q type, M/Q type, D/T type, D/T/Q type, D/Q type, T type and T/Q type.

The content (mol %) of each unit (organosiloxane unit) of the organopolysiloxane compound (A) is not particularly limited, and the total mole percent of the M unit, D unit and T unit is preferably not lower than 15 mol % and more preferably not lower than 20 mol %. The upper limit of the content is not particularly limited and, when the compound (A) is composed of the M unit, D unit and T unit, the total mole percent thereof may be 100 mol %.

The constitutional unit may be measured by means of, for example, ²⁹Si-NMR.

R in the M unit, D unit and T unit represents a monovalent organic group. Examples of the monovalent organic group include monovalent aliphatic groups (e.g., alkyl group, alkenyl group), monovalent aromatic groups (aryl group, heteroaryl group), cyano group, nitro group, carboxyl group, alkoxy group, aryloxy group, carbamoyloxy group, alkylthio group, arylthio group, sulfo group, arylsulfinyl group, aryloxycarbonyl group, carbamoyl group, hydroxy group, amino group, epoxy group, and groups that are combinations thereof. Of these, preferred monovalent organic groups include monovalent aliphatic groups, monovalent aromatic groups, alkoxy group and hydroxy group.

Each of those monovalent organic groups may be further substituted with a monovalent organic group as a substituent.

The organopolysiloxane compound (A) contains, in the molecule, at least the unit X including a group having a phenyl group (organosiloxane unit X) and the unit Y including a group having an alkyl group with 1 to 3 carbon atoms (organosiloxane unit Y).

The unit X is a unit including a group having a phenyl group as R and may be any of the M unit, the D unit and the T unit. In other words, the unit X is at least one unit selected from the group consisting of the M unit (R₃SiO_{1/2}) including a group having a phenyl group as R, the D unit (R₂SiO) including a group having a phenyl group as R, and the T unit (RSiO_{3/2}) including a group having a phenyl group as R.

When the M unit includes a group having a phenyl group, it suffices if, of three Rs in the M unit, at least one R is a group having a phenyl group, and also two or three Rs may be groups each having a phenyl group.

When the D unit includes a group having a phenyl group, it suffices if, of two Rs in the D unit, at least one R is a group having a phenyl group.

The organopolysiloxane compound (A) preferably contains a unit selected from the group consisting of the M unit including a group having a phenyl group as R and the T unit including a group having a phenyl group as R because the invention can have more excellent effect(s).

One preferred embodiment of the group having a phenyl group is a group expressed by Formula (A):

*—W—(Z₁)ₙ Formula (A)

In Formula (A), W is a single bond or an (n+1) valent linking group. Z₁ is a phenyl group.

Examples of the (n+1) valent linking group represented by W include alkylene groups (preferably having 1 to 20 carbon atoms), —O—, —S—, arylene groups, —CO—, —NR—, —SO₂—, —COO—, —CONR—, —N<, —C(R)<, >C<, and groups that are combinations thereof. R is a hydrogen atom or an alkyl group.

n is an integer of 1 to 4, preferably 1 to 3 and more preferably 1. * is a bonding position with a silicon atom (Si atom). When n is 1, W is a divalent linking group.

The ratio (β/α) between the molar quantity of the unit X (α) and the molar quantity of all constitutional units (all organosiloxane units) (β) is 1.5 or higher, and because the invention can have more excellent effect(s), preferably 3.0 or higher and more preferably 3.5 or higher. The upper limit of the ratio is not particularly limited but is preferably 10 or lower.

A ratio (β/α) of lower than 1.5 leads to poor adhesion as well as poor corrosion resistance and adhesion after exposure to a high temperature environment.

The unit Y is a unit including a group having an alkyl group with 1 to 3 carbon atoms as R and may be any of the M unit, the D unit and the T unit. In other words, the unit Y is at least one unit selected from the group consisting of the M unit (R₃SiO_{1/2}) including a group having an alkyl group with 1 to 3 carbon atoms as R, the D unit (R₂SiO) including a group having an alkyl group with 1 to 3 carbon atoms as R, and the T unit (RSiO_{3/2}) including a group having an alkyl group with 1 to 3 carbon atoms as R.

When the M unit includes a group having an alkyl group with 1 to 3 carbon atoms, it suffices if, of three Rs in the M unit, at least one R is a group having an alkyl group with 1 to 3 carbon atoms, and also two or three Rs may be groups each having an alkyl group with 1 to 3 carbon atoms.

When the D unit includes a group having an alkyl group with 1 to 3 carbon atoms, it suffices if, of two Rs in the D unit, at least one R is a group having an alkyl group with 1 to 3 carbon atoms.

The organopolysiloxane compound (A) preferably contains a unit selected from the group consisting of the M unit including a group having an alkyl group with 1 to 3 carbon atoms as R and the T unit including a group having an alkyl group with 1 to 3 carbon atoms as R because the invention can have more excellent effect(s).

Examples of the alkyl group with 1 to 3 carbon atoms include methyl group, ethyl group, propyl group and isopropyl group, with methyl group and ethyl group being preferred.

One preferred embodiment of the group having an alkyl group with 1 to 3 carbon atoms is a group expressed by Formula (B):

*—W—(Z₂)ₙ Formula (B)

In Formula (B), the definitions of W and n are the same as those for Formula (A).

Z₂ is an alkyl group with 1 to 3 carbon atoms.

The ratio (β/γ) between the molar quantity of the unit Y (γ) and the molar quantity of all constitutional units (all organosiloxane units) (β) is not particularly limited but is preferably 1.0 to 10 and more preferably 1.5 to 5.0 because the invention can have more excellent effect(s).

The organopolysiloxane compound (A) has a weight-average molecular weight of 400 to 10,000 and preferably 500 to 9,000. When the weight-average molecular weight is less than 400, a resultant coating exhibits lower barrier properties, resulting in poor corrosion resistance, adhesion, water resistance, alkali resistance and solvent resistance. When the weight-average molecular weight exceeds 10,000, this leads to poor adhesion as well as poor corrosion resistance and adhesion after exposure to a high temperature environment.

The molecular weight can be measured by gel permeation chromatography (GPC) or NMR.

A method of manufacturing the organopolysiloxane compound (A) is not particularly limited, and one exemplary method involves subjecting a hydrolyzable silane compound having a predetermined group or a partial hydrolysate thereof to hydrolysis in the presence of acid and water, thereby obtaining the organopolysiloxane compound (A).

The hydrolyzable silane compound is a compound expressed by R₃SiX, R₂SiX₂, RSiX₃ or SiX₄ (where X is a halogen group such as a chlorine atom or a bromine atom or an alkoxy group such as a methoxy group or an ethoxy group, and R is a monovalent organic group). One exemplary method for manufacturing the organopolysiloxane compound (A) above is a method using a hydrolyzable silane compound including a group having a phenyl group and a hydrolyzable silane compound including a group having an alkyl group with 1 to 3 carbon atoms as well as at least one of a hydrolyzable silane compound expressed by RSiX₃ and a hydrolyzable silane compound expressed by SiX₄.

Examples of the hydrolyzable silane compound including a group having a phenyl group include phenyltriethoxysilane, phenyltrimethoxysilane and diphenyldimethoxysilane.

Examples of the hydrolyzable silane compound including a group having an alkyl group with 1 to 3 carbon atoms include trimethylsilyl chloride, triethylsilyl chloride, methyltrimethoxysilane, dimethyldimethoxysilane, methyltriethoxysilane, dimethyldiethoxysilane and n-propyltrimethoxysilane.

A silicone oil, a modified silicone oil and a silicone resin, each of which is composed of the M unit (R₃SiO_{1/2}), the D unit (R₂SiO) and other ingredients, may also be used as starting materials.

The conditions for manufacturing the organopolysiloxane compound (A) are appropriately selected according to a compound to be used. A solvent may be appropriately used in reaction, and exemplary solvents include an organic solvent selected from aromatic hydrocarbons such as toluene and xylene, aliphatic hydrocarbons such as hexane and octane, ketone compounds such as methyl ethyl ketone and methyl isobutyl ketone, ester compounds such as ethyl acetate and isobutyl acetate, and alcoholic compounds such as methanol, ethanol, 2-propanol, butanol, isobutanol and t-butanol; cyclic siloxanes such as octamethylcyclotetrasiloxane; and water.

### <Coated Aluminum Particles (B)>

The surface treatment agent for metal materials according to the invention contains the coated aluminum particles (B).

The coated aluminum particles (B) are particles having an average particle size of 5 to 30 μm and an aspect ratio (length/thickness) of 10 to 400 as obtained by treating the surfaces of aluminum particles with an organosilane compound having a hydrolyzable group bonded to a silicon atom in one molecule (hereinafter sometimes simply called “organosilane compound”). That is, the coated aluminum particles (B) are particles having an average particle size of 5 to 30 μm and an aspect ratio (length/thickness) of 10 to 400 as obtained by treating surfaces of aluminum particles with the organosilane compound. In other words, the coated aluminum particles (B) each include an aluminum particle and a surface treatment coating formed of the organosilane compound.

The type of the aluminum particles that are material particles to be subjected to surface treatment using the organosilane compound is not particularly limited, and any particles may be used as long as they are made of aluminum or aluminum alloy. The purity of the aluminum alloy is not particularly limited.

The average particle size of the coated aluminum particles (B) is 5 to 30 μm and preferably 6 to 25 μm because the invention can have more excellent effect(s). The average particle size of less than 5 μm leads to poor corrosion resistance and adhesion after exposure to a high temperature environment. The average particle size of greater than 30 μm leads to poor corrosion resistance and alkali resistance.

The average particle size can be measured by, for instance, a known particle size distribution measurement method.

The aspect ratio (length/thickness) of the coated aluminum particles (B) is 10 to 400 and preferably 130 to 300 because the invention can have more excellent effect(s). The aspect ratio (length/thickness) of less than 10 leads to poor corrosion resistance and water resistance. The aspect ratio (length/thickness) of greater than 400 leads to poor adhesion as well as poor corrosion resistance and adhesion after exposure to a high temperature environment.

The term “aspect ratio (length/thickness)” above represents a ratio between the length and the thickness of the coated aluminum particles (B). With regard to the length of the coated aluminum particles (B), of pairs of parallel planes tangent to a coated aluminum particle (B) in a three dimensional shape, a pair of parallel planes having the maximum distance therebetween is selected, and the maximum distance is defined as the “length”; and, of pairs of parallel planes that are orthogonal to the pair of parallel planes associated with the “length” and are tangent to the coated aluminum particle (B), a pair of parallel planes having the minimum distance therebetween is selected, and the minimum distance is defined as the “thickness.”

The aspect ratio is determined by measuring the lengths and thicknesses of at least fifty coated aluminum particles (B) with an electron microscope (a scanning electron microscope or a transmission electron microscope), calculating the aspect ratios of the respective coated aluminum particles (B), and obtaining the arithmetic mean of the aspect ratios.

The coated aluminum particles (B) are particles obtained by treating the surfaces of the aluminum particles with the organosilane compound. In other words, the coated aluminum particles (B) each include a surface treatment coating formed of the organosilane compound. Owing to surface treatment using the organosilane compound, the aluminum particles are provided on their surfaces with a component (e.g., silicon oxide) derived from the organosilane compound through a hydrolysis reaction and a condensation reaction of the organosilane compound.

When satisfying the average particle size and aspect ratio stated above, the coated aluminum particles (B) form an orientation layer having excellent barrier properties in a resultant coating. Owing to surface treatment of the coated aluminum particles (B) using the organosilane compound, siloxane bonds (Si—O bonds) are formed between the organopolysiloxane compound (A) and the coated aluminum particles (B), and the coated aluminum particles (B) are easily fixed in a coating formed from the organopolysiloxane compound (A). In particular, upon exposure to a high temperature environment, the coating does not contract and formation of siloxane bonds progresses, thus resulting in excellent corrosion resistance and adhesion even after exposure to a high temperature environment.

The method of treating the surfaces of the aluminum particles, which are a starting material, with the organosilane compound is not particularly limited, and an exemplary method involves adding the organosilane compound to a water slurry containing the aluminum particles, adjusting the pH of the mixture with acid or alkali, and then performing surface treatment at a temperature of 20° C. to 90° C. for 1 to 48 hours. Formation of surface treatment coatings on the aluminum particles is followed by filtration of a solution using, for instance, a filter press or a drum filter, washing away the remaining ingredients, and then drying a solid. Thereafter, the solid is made to be a water slurry again and crushed with a crusher such as a Dyno-Mill. This is one exemplary method.

One method of evaluating whether a surface treatment coating is present or not involves measurement using an X-ray fluorescence spectrometer (XRF).

The organosilane compound is a compound having a hydrolyzable group bonded to a silicon atom in one molecule. Examples of the hydrolyzable group include a halogen atom, alkoxy groups each having 1 to 4 (particularly, 1 or 2) carbon atoms such as methoxy group, ethoxy group, propoxy group and butoxy group, dialkylketoxime groups such as dimethylketoxime group, methyl ethyl ketoxime group and methyl isobutyl ketoxime group, alkenoxy groups each having 2 to 4 carbon atoms such as isopropenoxy group, and acyloxy groups such as acetoxy group.

In particular, a preferred organosilane compound is organoalkoxysilane. The organoalkoxysilane is a silane compound containing an alkoxy group as a hydrolyzable group.

The organosilane compound used in surface treatment of the coated aluminum particles (B) is not particularly limited, and preferred is the use of one or more selected from the group consisting of trimethylsilyl chloride, triethylsilyl chloride, chloromethyltrimethylsilane, methyltrimethoxysilane, dimethyldimethoxysilane, phenyltrimethoxysilane, methyltriethoxysilane, dimethyldiethoxysilane, phenyltriethoxysilane, n-propyltrimethoxysilane, hexyltrimethoxysilane, decyltriethoxysilane, hexamethyldisilazane, tetramethoxysilane, tetraethoxysilane, epoxysilane (3-glycidoxypropyltrimethoxysilane, 3-glycidoxypropylmethyldimethoxysilane or 2-(3,4-epoxycyclohexyl)ethyltrimethoxysilane), and aminosilane (N-(2-aminoethyl)3-aminopropylmethyldimethoxysilane, N-(aminoethyl)3-aminopropyltrimethoxysilane or 3-aminopropyltriethoxysilane). Of these, methyltrimethoxysilane and tetraethoxysilane are preferred because of improved corrosion resistance and adhesion after exposure to a high temperature environment.

The amount of coatings of the organosilane compound with respect to the aluminum particles is not particularly limited but is, when expressed as the amount of organosilane compound in percent by mass in terms of Si, preferably 0.1 to 20 mass %, and because the invention can have more excellent effect(s) (inter alia, because of further improved adhesion after exposure to a high temperature environment), more preferably 1 to 15 mass %, still more preferably 1 to 10 mass %, and particularly preferably 2 to 10 mass % with respect to the total solids of the aluminum particles.

The coated aluminum particle (B) content of the surface treatment agent for metal materials is not particularly limited; the mass ratio (B/A) between the organopolysiloxane compound (A) and the coated aluminum particles (B) is preferably 0.02 to 1.1, and because the invention can have more excellent effect(s) (inter alia, because of further improved corrosion resistance), more preferably 0.04 to 0.7 and still more preferably 0.09 to 0.35.

### <Component (C)>

The surface treatment agent for metal materials according to the present invention contains the component (C) including at least one selected from the group consisting of metal oxide particles and a clay mineral.

The component (C) is fixed in a coating formed from the organopolysiloxane compound (A) and the coated aluminum particles (B) and thereby serves to improve corrosion resistance after exposure to a high temperature environment.

An ingredient constituting the metal oxide particles in the component (C) is not particularly limited, and examples thereof include aluminum oxide, silicon oxide, silicate, phosphate, oxoacid salt, iron oxide, zirconium oxide, magnesium oxide, zirconium oxide, zinc oxide, titanium oxide, and composite oxides of these metals.

The clay mineral in the component (C) is for example a silicate mineral having a layer structure as formed by stacking multiple sheets. Each sheet forming a layer may be a sheet in which a number of tetrahedrons constituted of silicic acid are linked with each other along a plane or a sheet in which a number of octahedrons containing aluminum and magnesium are linked with each other along a plane.

Specific examples of the clay mineral (layered clay mineral) include ones of smectite group such as montmorillonite, bentonite, beidellite, hectorite and saponite; ones of vermiculite group; ones of mica group such as illite, muscovite, phlogopite and biotite; ones of brittle mica group such as margarite and clintonite; ones of chlorite group such as sudoite; ones of kaolin group such as kaolinite and halloysite; and ones of serpentine such as antigorite. Those clay minerals may be natural or synthetic and may also be used alone or in combination of two or more as appropriate.

In the present invention, use may be made of an intercalation compound of a layered clay mineral (e.g., pillared crystal), a substance having been subjected to ion-exchange treatment, and a substance having been subjected to surface treatment (e.g., silane coupling treatment, treatment for forming a composite with an organic binder).

For the component (C), those may be used alone or in combination of two or more.

The average particle size of the component (C) is not particularly limited but is preferably 0.05 to 3 μm, more preferably 0.1 to 0.5 μm and still more preferably 0.2 to 0.4 μm because the invention can have more excellent effect(s).

The average particle size can be measured by, for instance, a known particle size distribution measurement method.

One preferred embodiment of the component (C) is titanium oxide (c1).

The average particle size of the titanium oxide (c1) is not particularly limited but is preferably 0.05 to 3 μm, more preferably 0.1 to 0.5 μm and still more preferably 0.2 to 0.4 μm because the invention can have more excellent effect(s).

The titanium oxide (c1) is preferably titanium oxide having been subjected to surface treatment with an inorganic silicon compound. In other words, the titanium oxide (c1) preferably includes titanium oxide and a surface treatment coating formed from an inorganic silicon compound and disposed on the titanium oxide. Owing to surface treatment of titanium oxide using an inorganic silicon compound, siloxane bonds (Si—O bonds) are formed between the organopolysiloxane compound (A) and the titanium oxide (c1), and the titanium oxide (c1) is more easily fixed in a coating formed from the organopolysiloxane compound (A), as with the coated aluminum particles (B). In particular, when a titanium oxide is subjected to surface treatment with an inorganic silicon compound that is not readily decomposed under a high temperature environment, this results in further excellent corrosion resistance after exposure to a high temperature environment.

The inorganic silicon compound used in surface treatment of the titanium oxide (c1) is not particularly limited in type, and examples thereof include alkali silicates such as sodium silicate, potassium silicate and lithium silicate; and colloidal silica and liquid-phase silica obtained by a process of solating after removal of sodium, potassium or lithium from these silicates by an ion-exchange method. Of these, lithium silicate is preferred because of further excellent corrosion resistance after exposure to a high temperature environment.

The amount of coating of the inorganic silicon compound in the titanium oxide (c1) is not particularly limited but is, when expressed as the amount of inorganic silicon compound in percent by mass in terms of Si, preferably 1 to 10 mass % and more preferably 2 to 8 mass % with respect to the total solids of titanium oxide. The amount within the foregoing ranges leads to excellent adhesion as well as more excellent corrosion resistance after exposure to a high temperature environment.

The method of performing surface treatment on titanium oxide with the inorganic silicon compound is not particularly limited, and an exemplary method involves adding the inorganic silicon compound to a water slurry containing the titanium oxide, adjusting the pH of the mixture with acid or alkali, and then performing surface treatment at a temperature of 20° C. to 90° C. for 1 to 48 hours. Formation of surface treatment coatings is followed by filtration of a solution using, for instance, a filter press or a drum filter, washing away the remaining ingredients, drying a solid, and then baking in a range of 500 to 900° C. Thereafter, the solid is made to be a water slurry again and crushed with a crusher such as a Dyno-Mill. This is one exemplary method.

One method of evaluating whether a surface treatment coating is present or not involves measurement using an X-ray fluorescence spectrometer (XRF).

The component (C) content of the surface treatment agent for metal materials is not particularly limited; the mass ratio (C/A) between the organopolysiloxane compound (A) and the component (C) is preferably 0.10 to 6.0, and because the invention can have more excellent effect(s) (inter alia, because of further improved corrosion resistance), more preferably 0.25 to 4.0, still more preferably 0.45 to 1.98 and particularly preferably 0.49 to 1.98.

The surface treatment agent for metal materials may contain a solvent for dissolving and dispersing coating ingredients and adjusting the concentrations of the ingredients.

The solvent is not particularly limited in type, and usable examples thereof include hexane, benzene, toluene, xylene, N-methylpyrrolidone and water (e.g., deionized water), with the use of deionized water being preferred because of easier handling of the surface treatment agent.

The solvent content is preferably 30 to 90 mass % and more preferably 40 to 80 mass % with respect to the total amount of the surface treatment agent.

When water (e.g., deionized water) is used as the solvent, the surface treatment agent for metal materials preferably has a pH of 6 to 10. The pH within the foregoing range leads to more excellent corrosion resistance and water resistance. The pH is more preferably 8 to 10 with the center value of 9.

The pH is adjusted preferably by means of ammonia, carbonic acid, nitric acid, organic acid or the like.

The surface treatment agent for metal materials may contain a surfactant.

The surfactant is not particularly limited in type, and examples thereof include an anionic surfactant, a nonionic surfactant and a cationic surfactant.

In order to emulsify and disperse the organopolysiloxane compound (A) in the surface treatment agent for metal materials, the surface treatment agent for metal materials to which a surfactant has been added may optionally be subjected to stirring treatment using a stirrer such as a homomixer or a disper mixer or an emulsifying device such as a high pressure homogenizer or a colloid mill.

The method of manufacturing the surface treatment agent for metal materials is not particularly limited, and an exemplary method involves adding predetermined amounts of the foregoing main ingredients (organopolysiloxane compound (A), coated aluminum particles (B) and component (C)) to a predetermined solvent, optionally adjusting the pH of the solution, and mixing the solution.

Another possible method involves adding the organopolysiloxane compound (A) to an aqueous solution containing a surfactant and water, subjecting the resulting aqueous solution to the stirring treatment above to produce an emulsified dispersion, and then further adding the other ingredients to the emulsified dispersion, thereby preparing the surface treatment agent for metal materials.

### <Metal Material Having Surface Treatment Coating>

The metal material having a surface treatment coating can be manufactured using the foregoing surface treatment agent for metal materials. More specifically, a metal material is subjected to surface treatment with the foregoing surface treatment agent for metal materials to thereby obtain the metal material having a surface treatment coating, with the metal material having a surface treatment coating comprising the metal material and a coating disposed on/over the metal material.

The metal material for use is not particularly limited in type, and examples thereof include metal materials such as iron-based metal materials, galvanized steel sheets, aluminum-based metal materials, magnesium-based metal materials, nickel-based metal materials, titanium-based metal materials, zirconium-based metal materials, copper-based metal materials and tin-based metal materials.

The surface treatment method using the surface treatment agent for metal materials is not particularly limited, and a preferred surface treatment method involves bringing a surface of the metal material into contact with the surface treatment agent for metal materials, optionally followed by drying (preferably under heating), thereby forming a coating on/over the surface of the metal material. In particular, the method involving applying the surface treatment agent for metal materials is preferred. In other words, the foregoing surface treatment agent for metal materials is preferably used as a coating type surface treatment agent.

The amount of coating deposited is not particularly limited but is preferably 3 to 40 g/m² and more preferably 5 to 30 g/m² because the invention can have more excellent effect(s).

The metal material may be optionally pretreated prior to application in order to remove oil and stains on the surface of the metal material. For instance, anti-rust oil for rust prevention purposes or press oil for use in pressing is often applied to the metal material. Even in cases where such oil is not applied, oil and stains may adhere to the metal material during the operation. Owing to cleaning through pretreatment, the metal material surface easily gets wet in a uniform manner.

The method of the pretreatment is not particularly limited, and examples thereof include rinsing with hot water, rinsing with a solvent, cleaning by alkaline degreasing, and pickling. The pretreatment step is not particularly necessary in cases where the metal material surface has no oil or stain and uniformly gets wet with the surface treatment agent for metal materials according to the invention.

The method of bringing the metal material into contact with the surface treatment agent for metal materials according to the invention is not particularly limited, and preferred are methods involving applying the surface treatment agent for metal materials onto the metal material surface in a uniform manner, as exemplified by roll coating, dip coating and spray coating.

The heating temperature at the time of drying the coating formed on/over the metal material surface is not particularly limited but is preferably not higher than 280° C. and more preferably not higher than 250° C. A heating temperature of not higher than 280° C. requires no special equipment and is therefore quite widely adaptable in the industry.

The method of drying under heating is not particularly limited, and the surface treatment agent may be dried under heating by hot air, an induction heater, infrared light, near infrared light or the like in an air environment. An optimal heating time is suitably selected according to, for example, the type of compound in the surface treatment agent for metal materials to be used.

As described above, according to the present invention, the surface treatment agent is obtained that can form a coating being comprehensively satisfactory in such properties as corrosion resistance, adhesion, water resistance, alkali resistance and solvent resistance and being capable of preventing corrosion resistance and adhesion from deteriorating even upon exposure to a high temperature environment, that is, having excellent corrosion damage resistance, thereby achieving intended purposes of electronic parts over a long period of time.

### Examples

The operations and effects of the present invention are specifically illustrated below by way of examples. The examples below should not be construed as limiting the invention, and modifications in design according to a change in conditions are intended to fall within the scope of the invention.

### (1) Test Material (Base Material)

The following commercially available material was used for the test material.

(i) Cold-rolled steel sheet SPCC-SD: sheet thickness, 0.8 mm

### (2) Pretreatment (Cleaning)

In the method of producing a test plate, the surfaces of the test material were first treated with FINECLEANER E6406 manufactured by Nihon Parkerizing Co., Ltd. to remove oil and stains on the surfaces. Next, the test material was rinsed with tap water, and the test material surfaces were confirmed to be thoroughly (100%) wet by water. Then, pure water was poured onto the test material surfaces, and the test material was put in an oven in an atmosphere of 100° C. to remove moisture and used as a test plate.

### (3) Preparation of Surface Treatment Agent for Metal Materials

Ingredients in blending amounts (at blending ratios) shown in Table 4 with respect to the total solids of a surface treatment agent for metal materials were mixed in water, thereby obtaining a surface treatment agent for metal materials (solid concentration: 10 to 60 mass %).

Other than “Compound (A)” (organopolysiloxane compound (A)), “Particles (B)” (coated aluminum particles (B)) and “Component (C)” shown in Table 4, a main ingredient was water.

In Table 4, “mass %” in the “Compound (A)” column represents “mass %” with respect to the total solids in a surface treatment agent for metal materials.

In Table 4, “B/A” in the “Particles (B)” column represents “mass of particles (B)/mass of compound (A).”

In Table 4, “C/A” in the “Component (C)” column represents “mass of component (C)/mass of compound (A).”

The pH was adjusted with ammonia water, nitric acid or the like.

The ingredients shown in Table 4 are described below. For the compound (A), aqueous dispersions of compounds (A) were prepared and used as described below.

### <Compound (A)>

A1: Dimethyldimethoxysilane and phenyltrimethoxysilane were mixed at a ratio of 2.9 mol:0.3 mol, and added to a mixed solution of methyl ethyl ketone and deionized water, and the resultant mixture was reacted with stirring for 2.5 hours. Subsequently, the mixture was heated to reflux to remove the solvents, thereby obtaining a compound A1 with β/α of 12.6.

The compound A1 was added to deionized water to a solid concentration of 50 mass %, and the mixture was stirred for 2.0 hours with a homogenizer.

Through ²⁹Si-NMR measurement, signals of the M unit, D unit and T unit were detected. The weight-average molecular weight of the compound A1 was measured by GPC (polystyrene equivalent) and as a result was about 2,200.

A2: Dimethyldimethoxysilane, phenyltrimethoxysilane and tetramethoxysilane were mixed at a ratio of 2.5 mol:0.3 mol:0.3 mol, and added to a mixed solution of methyl ethyl ketone and deionized water, and the resultant mixture was reacted with stirring for 2.5 hours. Subsequently, the mixture was heated to reflux to remove the solvents, thereby obtaining a compound A2 with β/α of 12.2.

The compound A2 was added to deionized water to a solid concentration of 50 mass %, and the mixture was stirred for 2.0 hours with a homogenizer.

Through ²⁹Si-NMR measurement, signals of the M unit, D unit, T unit and Q unit were detected. The weight-average molecular weight of the compound A2 was measured by GPC and as a result was about 3,100.

A3: Diphenyldimethoxysilane and methyltrimethoxysilane were mixed at a ratio of 0.2 mol:2.6 mol, and added to a mixed solution of methyl ethyl ketone and deionized water, and the resultant mixture was reacted with stirring for 2.5 hours. Subsequently, the mixture was heated to reflux to remove the solvents, thereby obtaining a compound A3 with β/α of 13.6.

The compound A3 was added to deionized water to a solid concentration of 50 mass %, and the mixture was stirred for 2.0 hours with a homogenizer.

Through ²⁹Si-NMR measurement, signals of the M unit, D unit and T unit were detected. The weight-average molecular weight of the compound A3 was measured by GPC and as a result was about 1,600.

A4 to A7: Changing the reaction time for A2 above, a compound A4 with β/α of 12.2 and a weight-average molecular weight of about 440, a compound A5 with β/α of 12.2 and a weight-average molecular weight of about 9,200, a compound A6 with β/α of 12.2 and a weight-average molecular weight of about 280 and a compound A7 with β/α of 12.2 and a weight-average molecular weight of about 11,620 were obtained, all of which were composed of the M unit, D unit, T unit and Q unit.

A8: A commercially available silicone resin (compound A8) composed of the M unit, D unit and T unit with β/α of 6.2 and a weight-average molecular weight of about 6,500 was added to deionized water to a solid concentration of 50 mass %, and the mixture was stirred for 2.0 hours with a homogenizer.

A9: Dimethyldimethoxysilane and phenyltrimethoxysilane were mixed at a ratio of 0.4 mol:1.8 mol, and added to a mixed solution of methyl ethyl ketone and deionized water, and the resultant mixture was reacted with stirring for 2.5 hours. Subsequently, the mixture was heated to reflux to remove the solvents, thereby obtaining a compound A9 with β/α of 1.2.

Through ²⁹Si-NMR measurement, signals of the M unit, D unit and T unit were detected. The weight-average molecular weight of the compound A9 was measured by GPC and as a result was about 900.

A10: Dimethyldimethoxysilane and phenyltrimethoxysilane were mixed at a ratio of 1.3 mol:1.3 mol, and added to a mixed solution of methyl ethyl ketone and deionized water, and the resultant mixture was reacted with stirring at 50° C. to 60° C. for 2.5 hours. Subsequently, the mixture was heated to reflux to remove the solvents, thereby obtaining a compound A10 with β/α of 2.0.

The compound A10 was added to deionized water to a solid concentration of 50 mass %, and the mixture was stirred for 2.0 hours with a homogenizer.

Through ²⁹Si-NMR measurement, signals of the M unit, D unit and T unit were detected. The weight-average molecular weight of the compound A10 was measured by GPC and as a result was about 1,500.

TABLE 1

| | | | | Weight- | |
|---|---|---|---|---|---|
| | | | | average | |
| | | Constitutional | | molecular | |
| | Starting material | unit | β/α | weight | Remarks |
| A1 | Dimethyldimethoxysilane | M, D, T | 12.6 | 2200 | Example |
| | Phenyltrimethoxysilane | | | | |
| A2 | Dimethyldimethoxysilane | M, D, T, Q | 12.2 | 3100 | Example |
| | Phenyltrimethoxysilane | | | | |
| | Tetramethoxysilane | | | | |
| A3 | Diphenyldimethoxysilane | M, D, T | 13.6 | 1600 | Example |
| | Methyltrimethoxysilane | | | | |
| A4 | Same as in A2 | M, D, T, Q | 12.2 | 440 | Example |
| A5 | Same as in A2 | M, D, T, Q | 12.2 | 9200 | Example |
| A6 | Same as in A2 | M, D, T, Q | 12.2 | 280 | Comparative |
| | | | | | example |
| A7 | Same as in A2 | M, D, T, Q | 12.2 | 11620 | Comparative |
| | | | | | example |
| A8 | — | M, D, T | 6.2 | 6500 | Example |
| A9 | Dimethyldimethoxysilane | M, D, T | 1.2 | 900 | Comparative |
| | Phenyltrimethoxysilane | | | | example |
| A10 | Dimethyldimethoxysilane | M, D, T | 2 | 1500 | Example |
| | Phenyltrimethoxysilane | | | | |

### <Particles (B)>

B1: An aluminum pigment (aluminum particles) was added to a mixed solution of 2-propanol and deionized water to adjust the solid concentration to 20%. Subsequently, methyltrimethoxysilane was added in an amount in percent by mass of 5% in terms of Si with respect to the total solids of the aluminum pigment, and the mixture was stirred at 50° C. to 60° C. for 2.5 hours. Thereafter, the resulting solution was separated into a solid and a liquid through a filter, and the solid was dried. The resulting solid was dispersed in water again and crushed for 3.0 hours with a Dyno-Mill, thereby obtaining particles B1 with an average particle size of 7 μm and an aspect ratio (length/thickness) of 230.

B2: Particles B2 with an average particle size of 10 μm and an aspect ratio of 290 were obtained by the same procedures as those for B1 above except that methyltrimethoxysilane was replaced by tetramethoxysilane.

B3 to B5: Changing the crushing time for B2 above, particles B3 with an average particle size of 1 μm and an aspect ratio of 9, particles B4 with an average particle size of 5 μm and an aspect ratio of 120, and particles B5 with an average particle size of 32 μm and an aspect ratio of 210 were obtained. For the particles B5, crushing was not performed.

B6: Particles B6 with an average particle size of 9 μm and an aspect ratio of 280 were obtained by the same procedures as those for B2 above except that the amount of added tetramethoxysilane was changed from 5 mass % to 0.5 mass %.

B7: Particles B7 with an average particle size of 13 μm and an aspect ratio of 200 were obtained by the same procedures as those for B2 above except that the amount of added tetramethoxysilane was changed from 5 mass % to 16 mass %.

B8: An aluminum pigment was added to a mixed solution of 2-propanol and deionized water to adjust the solid concentration to 20 mass %. Thereafter, the resulting solution was separated into a solid and a liquid through a filter, and the solid was dried. The resulting solid was dispersed in water again and crushed for 3.0 hours with a Dyno-Mill, thereby obtaining particles B8 with an average particle size of 12 μm and an aspect ratio of 260.

The particles B8 were not subjected to surface treatment using an organosilane compound having a hydrolyzable group bonded to a silicon atom in one molecule.

TABLE 2

| | Average | | |
|---|---|---|---|
| | particle size | Aspect ratio | |
| | (μm) | (length/thickness) | Remarks |
| B1 | 7 | 230 | Example |
| B2 | 10 | 290 | Example |
| B3 | 1 | 9 | Comparative |
| | | | example |
| B4 | 5 | 120 | Example |
| B5 | 32 | 210 | Comparative |
| | | | example |
| B6 | 9 | 280 | Example |
| B7 | 13 | 200 | Example |
| B8 | 12 | 260 | Comparative |
| | | | example |

### <Component (C)>

C1: A titanium oxide pigment was added to deionized water to adjust the solid concentration to 20 mass %. Subsequently, lithium silicate was added in an amount in percent by mass of 5% in terms of Si with respect to the total solids of the titanium oxide pigment, and the mixture was stirred at 50° C. to 60° C. for 2.5 hours. Thereafter, the resulting solution was separated into a solid and a liquid through a filter, and the solid was dried. The resulting solid was baked at 600° C. for 1.0 hour, dispersed in water again and crushed with a Dyno-Mill, thereby obtaining particles C1 with an average particle size of 0.4 μm.

C2 to C3: Changing the crushing time for C1 above, particles C2 with an average particle size of 0.05 μm and particles C3 with an average particle size of 2.3 μm were obtained.

C4: A titanium oxide pigment was added to deionized water to adjust the solid concentration to 20 mass %. Thereafter, the pigment was crushed with a Dyno-Mill, thereby obtaining particles C4 with an average particle size of 0.4 μm.

C5: Kaolin clay was added to deionized water to adjust the solid concentration to 20 mass %. Thereafter, the clay was crushed with a Dyno-Mill, thereby obtaining particles C5 with an average particle size of 0.3 μm.

In Table 3, “Modified titanium oxide particles” represents “titanium oxide having undergone surface treatment with an inorganic silicon compound,” and “Unmodified titanium oxide particles” represents particles having not undergone surface treatment.

TABLE 3

| | | Average |
|---|---|---|
| | | particle size |
| | Type | (μm) |
| C1 | Modified titanium oxide particles | 0.4 |
| C2 | Modified titanium oxide particles | 0.05 |
| C3 | Modified titanium oxide particles | 2.3 |
| C4 | Unmodified titanium oxide particles | 0.4 |
| C5 | Kaolin clay | 0.3 |

### (4) Treatment Method

Each test plate was coated with a surface treatment agent for metal materials prepared as above by bar coating, put in an oven without rinsing with water and dried at a drying temperature of 250° C. to thereby form a coating with a coating weight per sheet side of 15 g/m² on the relevant test plate.

### (5) Method of Evaluation Test

### (5-1) Corrosion Resistance

Each coated test plate was cut into a size of 70 mm×150 mm, the test piece obtained with its back and edges being covered with cellophane tape underwent the salt spray test defined in JIS Z 2371, and the time taken until rust occurred to an area ratio of 5% on the coated surface was evaluated.

Excellent: It took 120 hours or more until rust occurred to an area ratio of 5%.
Good: It took 48 hours or more but less than 120 hours until rust occurred to an area ratio of 5%.
Fair: It took 24 hours or more but less than 48 hours until rust occurred to an area ratio of 5%.
Poor: It took less than 24 hours until rust occurred to an area ratio of 5%.

### (5-2) Adhesion

With each coated test plate, the coating was provided with one-hundred, 1 mm grid squares, and tape peeling was performed according to JIS K 5400. The number of squares where the coating was not peeled off but remained was counted and evaluated as the remaining rate.

Excellent: The remaining rate was 91% to 100%.
Good: The remaining rate was 71% to 90%.
Fair: The remaining rate was 51% to 70%.
Poor: The remaining rate was 0% to 50%.

### (5-3) Water Resistance

Each coated test plate was cut into a size of 70 mm×150 mm, the test piece obtained with its back and edges being covered with cellophane tape was immersed in hot water at 50° C., and the time taken until rust occurred to an area ratio of 5% on the coated surface was evaluated.

Excellent: It took 600 hours or more until rust occurred to an area ratio of 5%.
Good: It took 360 hours or more but less than 600 hours until rust occurred to an area ratio of 5%.
Fair: It took 120 hours or more but less than 360 hours until rust occurred to an area ratio of 5%.
Poor: It took less than 120 hours until rust occurred to an area ratio of 5%.

### (5-4) Alkali Resistance

Each coated test plate was cut into a size of 70 mm×75 mm, the test piece obtained with its back and edges being covered with cellophane tape was immersed in 5% NaOH aqueous solution, and the appearance of the coated surface after 240 hours was evaluated.

Excellent: Neither change nor peeling was observed.
Good: Slight color change was observed but no peeling.
Fair: Color change was observed but no peeling.
Poor: A coating was partially peeled off.

### (5-5) Solvent Resistance

Each coated test plate was cut into a size of 70 mm×75 mm, the test piece obtained with its back and edges being covered with cellophane tape was immersed in methyl ethyl ketone, and the appearance of the coated surface after 240 hours was evaluated.

Excellent: No change was observed.
Good: Change was slightly observed.
Fair: Color change was observed.
Poor: A coating was partially peeled off.
(5-6) Corrosion Resistance and Adhesion after Exposure to High Temperature Environment

Each coated test plate was cut into a size of 70 mm×150 mm, and the test piece obtained was heated in an oven at 600° C. for 24 hours and allowed to stand at room temperature for 24 hours. Thereafter, the test piece with its back and edges being covered with cellophane tape underwent the same tests as in (5-1) Corrosion Resistance and (5-2) Adhesion.

The metal materials obtained by using the surface treatment agents for metal materials described in examples and comparative examples were evaluated as described in (5-1) to (5-6), and the results are shown in Table 4.

From the practical point of view, the metal materials are required to be rated “Good” or “Excellent” in the above evaluation items.

TABLE 4

| | | Surface treatment agent for metal materials | | | | | | | Evaluation | | | | | | |
|---|---|---|---|---|---|---|---|---|---|---|---|---|---|---|---|
| | | Compound (A) | | | | | | | | | | | | Heat resistance | |
| | | | Mass | Particles (B) | | Particles (C) | | | Corrosion | Adhe- | Water | Alkali | Solvent | Adhe- | Corrosion |
| | | Type | % | Type | B/A | Type | C/A | pH | resistance | sion | resistance | resistance | resistance | sion | resistance |
| Example | 1 | A1 | 12.6 | B1 | 1.04 | C1 | 5.94 | 9 | Good | Good | Good | Good | Good | Good | Good |
| Example | 2 | A1 | 17.8 | B1 | 0.7 | C1 | 3.96 | 9 | Excellent | Good | Good | Good | Good | Good | Excellent |
| Example | 3 | A1 | 30.2 | B1 | 0.35 | C1 | 1.98 | 9 | Excellent | Excellent | Excellent | Excellent | Excellent | Excellent | Excellent |
| Example | 4 | A1 | 46.4 | B1 | 0.17 | C1 | 0.99 | 9 | Excellent | Excellent | Excellent | Excellent | Excellent | Excellent | Excellent |
| Example | 5 | A1 | 63.4 | B1 | 0.09 | C1 | 0.45 | 9 | Excellent | Excellent | Excellent | Excellent | Excellent | Excellent | Excellent |
| Example | 6 | A1 | 83.9 | B1 | 0.03 | C1 | 0.16 | 9 | Good | Good | Good | Good | Good | Good | Good |
| Example | 7 | A1 | 49.4 | B1 | 0.04 | C1 | 0.99 | 9 | Excellent | Excellent | Excellent | Excellent | Excellent | Good | Good |
| Example | 8 | A1 | 48.4 | B1 | 0.09 | C1 | 0.99 | 9 | Excellent | Excellent | Excellent | Excellent | Excellent | Excellent | Excellent |
| Example | 9 | A1 | 46.4 | B1 | 0.17 | C1 | 0.99 | 9 | Excellent | Excellent | Excellent | Excellent | Excellent | Excellent | Excellent |
| Example | 10 | A1 | 43 | B1 | 0.35 | C1 | 0.99 | 9 | Excellent | Excellent | Excellent | Excellent | Excellent | Excellent | Excellent |
| Example | 11 | A1 | 37.4 | B1 | 0.7 | C1 | 0.99 | 9 | Excellent | Good | Excellent | Excellent | Excellent | Good | Good |
| Example | 12 | A1 | 74.8 | B1 | 0.17 | C1 | 0.16 | 9 | Good | Good | Good | Good | Good | Good | Good |
| Example | 13 | A1 | 60.1 | B1 | 0.17 | C1 | 0.49 | 9 | Excellent | Excellent | Excellent | Excellent | Excellent | Excellent | Excellent |
| Example | 14 | A1 | 46.4 | B1 | 0.17 | C1 | 0.99 | 9 | Excellent | Excellent | Excellent | Excellent | Excellent | Excellent | Excellent |
| Example | 15 | A1 | 31.9 | B1 | 0.17 | C1 | 1.98 | 9 | Excellent | Excellent | Excellent | Excellent | Excellent | Excellent | Excellent |
| Example | 16 | A1 | 14.2 | B1 | 0.17 | C1 | 5.94 | 9 | Good | Good | Good | Good | Good | Good | Good |
| Example | 17 | A2 | 17.8 | B1 | 0.7 | C1 | 3.96 | 9 | Excellent | Good | Good | Good | Good | Good | Excellent |
| Example | 18 | A3 | 17.8 | B1 | 0.7 | C1 | 3.96 | 9 | Excellent | Good | Good | Good | Good | Excellent | Excellent |
| Example | 19 | A4 | 17.8 | B1 | 0.7 | C1 | 3.96 | 9 | Good | Good | Good | Good | Good | Good | Excellent |
| Example | 20 | A5 | 17.8 | B1 | 0.7 | C1 | 3.96 | 9 | Excellent | Good | Good | Good | Good | Good | Good |
| Example | 21 | A8 | 17.8 | B1 | 0.7 | C1 | 3.96 | 9 | Excellent | Good | Good | Good | Good | Good | Excellent |
| Example | 22 | A10 | 17.8 | B1 | 0.7 | C1 | 3.96 | 9 | Excellent | Good | Good | Good | Good | Good | Good |
| Example | 23 | A1 | 17.8 | B2 | 0.7 | C1 | 3.96 | 9 | Excellent | Good | Good | Good | Good | Excellent | Good |
| Example | 24 | A1 | 17.8 | B4 | 0.7 | C1 | 3.96 | 9 | Excellent | Good | Good | Good | Good | Good | Good |
| Example | 25 | A1 | 17.8 | B6 | 0.7 | C1 | 3.96 | 9 | Excellent | Good | Good | Good | Good | Good | Good |
| Example | 26 | A1 | 17.8 | B7 | 0.7 | C1 | 3.96 | 9 | Excellent | Good | Good | Good | Good | Good | Good |
| Example | 27 | A1 | 17.8 | B1 | 0.7 | C2 | 3.96 | 9 | Good | Good | Good | Good | Good | Good | Good |
| Example | 28 | A1 | 17.8 | B1 | 0.7 | C3 | 3.96 | 9 | Good | Good | Good | Good | Good | Good | Good |
| Example | 29 | A1 | 17.8 | B1 | 0.7 | C4 | 3.96 | 9 | Good | Good | Good | Good | Good | Good | Good |
| Example | 30 | A1 | 17.8 | B1 | 0.7 | C5 | 3.96 | 9 | Good | Good | Good | Good | Good | Good | Good |

TABLE 4

| | | Surface treatment agent for metal materials | | | | | | | Evaluation | | | | | | |
|---|---|---|---|---|---|---|---|---|---|---|---|---|---|---|---|
| | | Compound (A) | | | | | | | | | | | | Heat resistance | |
| | | | Mass | Particles (B) | | Particles (C) | | | Corrosion | Adhe- | Water | Alkali | Solvent | Adhe- | Corrosion |
| | | Type | % | Type | B/A | Type | C/A | pH | resistance | sion | resistance | resistance | resistance | sion | resistance |
| Comparative | 31 | — | — | B1 | — | C1 | — | 9 | Poor | Poor | Poor | Poor | Poor | Poor | Good |
| example | | | | | | | | | | | | | | | |
| Comparative | 32 | A1 | 50.5 | — | — | C1 | 0.99 | 9 | Good | Good | Fair | Fair | Good | Poor | Poor |
| example | | | | | | | | | | | | | | | |
| Comparative | 33 | A1 | 85.2 | B1 | 0.17 | — | — | 9 | Fair | Good | Good | Fair | Good | Poor | Poor |
| example | | | | | | | | | | | | | | | |
| Comparative | 34 | A6 | 17.8 | B1 | 0.7 | C1 | 3.96 | 9 | Fair | Poor | Fair | Fair | Fair | Poor | Excellent |
| example | | | | | | | | | | | | | | | |
| Comparative | 35 | A7 | 17.8 | B1 | 0.7 | C1 | 3.96 | 9 | Good | Poor | Good | Good | Good | Poor | Poor |
| example | | | | | | | | | | | | | | | |
| Comparative | 36 | A9 | 17.8 | B1 | 0.7 | C1 | 3.96 | 9 | Good | Poor | Good | Good | Good | Poor | Poor |
| example | | | | | | | | | | | | | | | |
| Comparative | 37 | A1 | 17.8 | B3 | 0.7 | C1 | 3.96 | 9 | Poor | Good | Poor | Good | Good | Poor | Poor |
| example | | | | | | | | | | | | | | | |
| Comparative | 38 | A1 | 17.8 | B5 | 0.7 | C1 | 3.96 | 9 | Poor | Fair | Good | Poor | Good | Fair | Excellent |
| example | | | | | | | | | | | | | | | |
| Comparative | 39 | A1 | 17.8 | B8 | 0.7 | C1 | 3.96 | 9 | Good | Fair | Good | Good | Good | Poor | Poor |
| example | | | | | | | | | | | | | | | |

As shown in Table 4, it was revealed that the metal materials treated with the surface treatment agents defined by the invention comprehensively satisfied such properties as corrosion resistance, adhesion, water resistance, alkali resistance and solvent resistance of the coatings, and their corrosion resistance and adhesion did not deteriorate even upon exposure to a high temperature environment.

In particular, as is evident from comparisons of Examples 1 to 16, it was confirmed that when the mass ratio (B/A) was 0.04 to 0.7 and the mass ratio (C/A) was 0.25 to 4.0, the effects were further excellent.

It was confirmed from comparisons of Examples 2 and 17 to 22 that when β/α was not less than 3.0 and the weight-average molecular weight was 500 to 9,000 (Examples 2, 17 to 18 and 21), the effects were further excellent.

It was confirmed from comparisons of Examples 2 and 23 to 26 that when the aluminum particles had an average particle size of 6 to 25 μm and the amount of used organosilane compound (in terms of Si) was 1 to 10 mass % with respect to the total solids of the aluminum particles (Examples 2 and 23), the effects were further excellent.

It was confirmed from comparisons of Examples 2 and 27 to 30 that when the component (C) had an average particle size of 0.1 to 0.5 μm and was titanium oxide having been subjected to surface treatment with an inorganic silicon compound (Example 2), the effects were further excellent.

On the other hand, in Comparative examples 30 and 34 to 36 using no predetermined compound (A), Comparative examples 32 and 37 to 39 using no predetermined particles (B), and Comparative example 33 using no predetermined component (C), desired effects were not achieved.

Also in cases of using not a cold-rolled steel sheet but an iron-based metal material, a copper-based metal materials and a magnesium-based metal material as a test material, the tendencies of evaluation results were similar to those for the foregoing examples using cold-rolled steel sheets, and metal materials each having a surface treatment coating with excellent properties were obtained.

1-5. (canceled)

6. A surface treatment agent for metal materials, comprising:
an organopolysiloxane compound (A) that is composed of one unit selected from the group consisting of an M unit (R₃SiO_{1/2}), a D unit (R₂SiO), a T unit (RSiO_{3/2}) and a Q unit (SiO₂), has a three-dimensional network structure including at least the T unit and/or the Q unit in a molecule, contains in a molecule a unit X including a group having a phenyl group and a unit Y including a group having an alkyl group with 1 to 3 carbon atoms, has a ratio (β/α) between a molar quantity of the unit X (α) and a molar quantity of all constitutional units (β) of 1.5 or higher, and has a weight-average molecular weight of 400 to 10,000 (where each R independently represents a monovalent organic group);
coated aluminum particles (B) that have an average particle size of 5 to 30 μm and an aspect ratio (length/thickness) of 10 to 400 and are obtained by treating surfaces of aluminum particles with an organosilane compound having a hydrolyzable group bonded to a silicon atom in a molecule; and
a component (C) including at least one selected from the group consisting of metal oxide particles and a clay mineral.

7. The surface treatment agent for metal materials according to claim 6,
wherein the organopolysiloxane compound (A) is contained in an amount of 14 to 74 mass % with respect to total solids of the surface treatment agent for metal materials, and
wherein a mass ratio (B/A) between the organopolysiloxane compound (A) and the coated aluminum particles (B) is 0.04 to 0.7.

8. The surface treatment agent for metal materials according to claim 6,
wherein a mass ratio (C/A) between the organopolysiloxane compound (A) and the component (C) is 0.25 to 4.0.

9. The surface treatment agent for metal materials according to claim 7,
wherein a mass ratio (C/A) between the organopolysiloxane compound (A) and the component (C) is 0.25 to 4.0.

10. The surface treatment agent for metal materials according to claim 6,
wherein the component (C) includes metal oxide particles, and
wherein the metal oxide particles have an average particle size of 0.1 to 0.5 μm and contain titanium oxide (c1) having been subjected to surface treatment with an inorganic silicon compound.

11. The surface treatment agent for metal materials according to claim 7,
wherein the component (C) includes metal oxide particles, and
wherein the metal oxide particles have an average particle size of 0.1 to 0.5 μm and contain titanium oxide (c1) having been subjected to surface treatment with an inorganic silicon compound.

12. The surface treatment agent for metal materials according to claim 8,
wherein the component (C) includes metal oxide particles, and
wherein the metal oxide particles have an average particle size of 0.1 to 0.5 μm and contain titanium oxide (c1) having been subjected to surface treatment with an inorganic silicon compound.

13. The surface treatment agent for metal materials according to claim 9,
wherein the component (C) includes metal oxide particles, and
wherein the metal oxide particles have an average particle size of 0.1 to 0.5 μm and contain titanium oxide (c1) having been subjected to surface treatment with an inorganic silicon compound.

14. A metal material having a surface treatment coating, comprising: a metal material; and a coating formed by bringing the surface treatment agent for metal materials according to claim 6 into contact with a surface of the metal material.

15. A metal material having a surface treatment coating, comprising: a metal material; and a coating formed by bringing the surface treatment agent for metal materials according to claim 7 into contact with a surface of the metal material.

16. A metal material having a surface treatment coating, comprising: a metal material; and a coating formed by bringing the surface treatment agent for metal materials according to claim 8 into contact with a surface of the metal material.

17. A metal material having a surface treatment coating, comprising: a metal material; and a coating formed by bringing the surface treatment agent for metal materials according to claim 9 into contact with a surface of the metal material.

18. A metal material having a surface treatment coating, comprising: a metal material; and a coating formed by bringing the surface treatment agent for metal materials according to claim 10 into contact with a surface of the metal material.

19. A metal material having a surface treatment coating, comprising: a metal material; and a coating formed by bringing the surface treatment agent for metal materials according to claim 11 into contact with a surface of the metal material.

20. A metal material having a surface treatment coating, comprising: a metal material; and a coating formed by bringing the surface treatment agent for metal materials according to claim 12 into contact with a surface of the metal material.

21. A metal material having a surface treatment coating, comprising: a metal material; and a coating formed by bringing the surface treatment agent for metal materials according to claim 13 into contact with a surface of the metal material.
